(19) United States
(12) Patent Application Publication
(10) Pub. No.: US 2013/0334341 A1
(43) Pub. Date: Dec. 19, 2013

(54) Scent Sampler

(71) Applicant: James Berard, Pleasantville, NY (US)

(72) Inventor: James Berard, Pleasantville, NY (US)

(73) Assignee: SCENTISPHERE LLC, Carmel, NY (US)

(21) Appl. No.: 13/523,661

(22) Filed: Jun. 14, 2012

(51) Int. Cl. B05B 15/00; B23P 11/00

(52) U.S. Cl. 239/289; 29/428

(57) ABSTRACT

A scent sampler has a sponge-like wafer infused with a fragrance liquid within a chamber between two printable panels. A window to the chamber is covered with a thin, flexible, nonresilient film which may be pressed against the wafer for spraying a mist of the fragrance liquid through an opening in the chamber to the ambient environment. The surfaces of the printable panels are covered with a liquid-impervious barrier web to prevent leakage of the fragrance liquid from, and damage to, the printed surfaces within and outside of the chamber.

### BACKGROUND OF THE INVENTION

It is known in the art to provide small doses of a perfume, cologne or similar fragrance product for sampling by a prospective consumer. The fragrances are sometimes coated onto a paper surface on which an advertisement for the product is printed and included in a magazine, or sent in a mailer to consumers. Small amounts of the cologne or perfume can also be provided in bottles or other containers.

In the case of coated paper, the consumer does not have the same experience as spraying a mist of the perfume or cologne from a bottle as would be done in normal use. Providing the consumer with a sample in a bottle or other container is relatively expensive.

The present invention overcomes the shortcomings of the prior art in providing an inexpensive device from which a sample of a perfume, cologne, or other product based on a fragrance liquid can be sprayed into the air as a mist and sniffed by the consumer to sample the scent in a way similar to using the full product.

### SUMMARY OF THE INVENTION

The present invention provides for a scent sampler constructed from a laminate including a substrate having a printable surface, e.g., a substrate of paper based stock, e.g., cardboard, plastic having a surface adapted to accept ink, dye or pigments, or a similar printable material, having a surface which has optionally been printed before being covered by a liquid-impervious plastic film having a thermosetting adhesive coating on its exposed surface.

Two separate panels of the laminate can be placed together, or two adjacent panels of a single laminate can be folded onto one another, so that a window cut into a front one of the panels overlaps an area of a rear one of the panels. Before the two panels are sealed together under a heated die, a sponge-like absorbent and resilient wafer, infusible with a fragrance liquid, is affixed to the front surface of the rear panel within the border of the window. The window is covered by a layer of a thin, flexible, nonresilient film sandwiched between the panels of the laminate. The film covering of the window serves as a flexible, non-resilient wall of a chamber housing the fragrance liquid-containing wafer when the panels are adhered together via the thermosetting adhesive. The film may be opaque for hiding the wafer or transparent to permit viewing of the wafer and/or printing on the rear panel through the window while preventing leakage or evaporation of the fragrance liquid in the wafer into or through the panels of the sampler.

For sampling the fragrance, a small spray opening can be provided in the film, within the window, in registration with the wafer, permitting a mist of the fragrance liquid in the wafer to be sprayed into the ambient air when the resilient wafer is compressed. Alternatively, a channel running between the front and rear panels, leading from the wafer at a border of the chamber to an opening in one of the panels may be provided, e.g., by not heating, or leaving free of adhesive, areas of the panels which form the walls of the channel. The spray opening may be in the front panel at a position remote from the wafer, or in an edge of the sampler at a seam between the front and rear panels.

It is therefore an object of the invention to provide a device for sampling a fragrance which has a leakproof chamber containing an absorbent wafer from which a mist of a fragrance liquid can be sprayed into the ambient environment, and having an interior wall which can be printed on a conventional printing press.

Another object of the invention is to provide a leakproof device for sampling a fragrance which has a transparent window through which printing on a wall within a chamber housing a fragrance liquid-containing wafer can be viewed.

Still another object of the invention is to provide a leakproof device for sampling a fragrance which has chamber with a window covered by a flexible non-resilient film which can be pressed against a fragrance liquid-containing wafer for spraying a mist of the fragrance liquid through an opening at a boundary of the chamber.

A further object of the invention is to provide a device for sampling a fragrance which has a chamber containing a fragrance liquid-containing wafer at a boundary thereof and an opening at the boundary through which a mist of the fragrance liquid can be dispensed to the ambient environment.

Still a further object of the invention is to provide a device for sampling a fragrance which has chamber containing a fragrance liquid-containing wafer at a boundary thereof, and an exit opening at the boundary through which a mist of the fragrance liquid can be dispensed into a channel leading to a spray opening remote from the wafer from which a mist of the fragrance liquid can be dispensed to the ambient environment.

Other and further objects of the invention will be apparent from the following drawings in which like reference numerals designate like parts in the various views.

### DESCRIPTION OF THE DRAWINGS

Referring now to the drawings,

FIG. 1 is an exploded perspective view of a first preferred embodiment of the invention;

FIG. 2 is a front elevation view of the first preferred embodiment of the invention;

FIG. 3 is sectional elevation view of the first preferred embodiment of the invention taken through line 3-3 of FIG. 2;

FIG. 4 is an exploded perspective view of a second preferred embodiment of the invention;

FIG. 5 is an exploded perspective view of a third preferred embodiment of the invention.

FIG. 6 is a front elevation view of the third preferred embodiment of the invention.

FIG. 7 is sectional elevation view of the third preferred embodiment of the invention taken through line 7-7 of FIG. 6.

FIG. 8 is a front elevation view of a fourth preferred embodiment of the invention.

FIG. 9 is top plan view of the fourth preferred embodiment of the invention.

### DESCRIPTION OF THE PREFERRED EMBODIMENTS

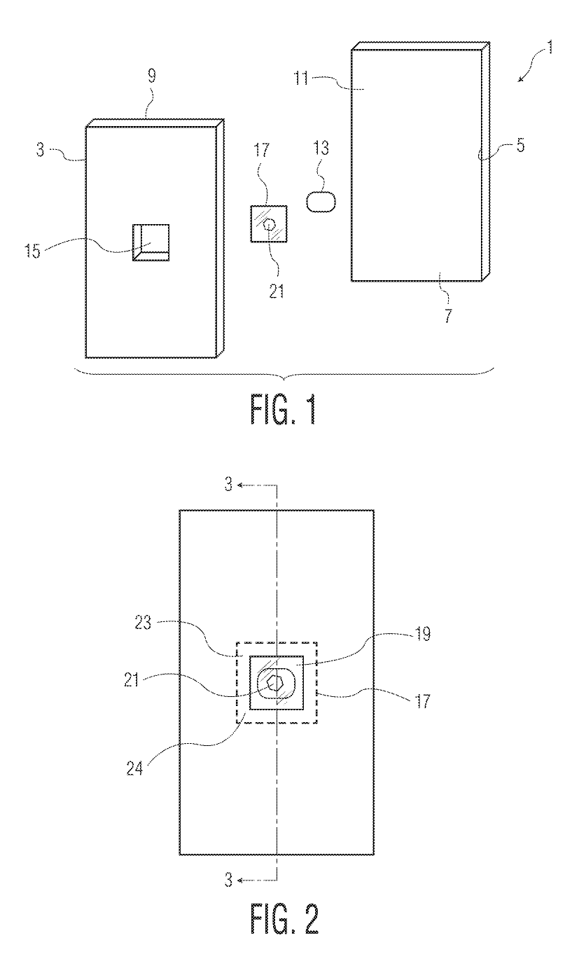

Referring now to FIG. 1 of the drawings there is shown an exploded perspective view of the sampler of the invention ready for assembly. A body of the sampler 1 is formed by joining a front panel 3 to a rear panel 5 each of which has a substrate cut from printable stock, e.g., cardboard or plastic, and a surface to which a transparent barrier film has been laminated. An exposed surface of the laminated barrier film, which forms the rear surface 9 of front panel 3 and the front surface 11 of rear panel 5 is coated with a dry thermosetting adhesive 7. The barrier film is liquid-impervious and, therefore prevents leakage of a fragrance liquid through panels 3 and 5. Such a thermosetting adhesive-coated barrier film is commercially available from Dikeman Laminating Corporation of Clifton, N.J.

The panels 3 and 5 are fastened by applying heat and pressure to urge them together whereby the thermosetting adhesive coating 7 of the barrier film that has been laminated to the mutually facing surfaces 9 and 11 of panels 3 and 5, bonds the panels 3 and 5 together to form a liquid tight hermetic seal. The panels 3 and 5 thereby enclose an interior liquid-tight chamber 19 housing the foam wafer 13 which can be infused with a fragrance liquid, e.g. a fragrance oil, either before or after the panels 3 and 5 are sealed together. The wafer 13 may be die cut from a mass of cellular foam material which may be of virtually any shape.

Front panel 3 has a window opening 15 which is covered by placing on the inside surface of the front panel 3 a thin sheet of thin, flexible, nonresilient film slightly larger in profile than the window opening 15. The sheet of film 17 may optionally be transparent. In accordance with the first embodiment of the invention, the sheet of film 17 has a small aperture 21 through which a mist of fragrance liquid can be sprayed by compressing wafer 13.

The thermosetting adhesive coated barrier film which is laminated onto the facing surfaces 9 and 11 of panels 3 and 5, and the flexible, nonresilient sheet of film 17 which covers the window 15 are selected so as not to be degradable by the fragrance liquid. Also, the foam material in the wafer 13 is preferably a poly cellular foam material that will not chemically interact with or be deteriorated by a fragrance liquid. The wafer 13 may be made of polyester open cell hydrophilic foam.

Prior to assembly of the sampler 1, the foam, sponge-like wafer 13 may optionally be affixed to the front surface of the rear panel 5 by a spot of glue. Alternatively, an area of the front surface of the rear panel 5 to which the wafer 13 is to be affixed can be heated to melt the thermosetting adhesive 7 while the wafer 13 is pressed onto the rear panel 5 and held in place. The thermosetting adhesive 7 can then be allowed to cool thereby adhering the wafer 13 to the rear panel 5. Prior to assembly of the sampler, a rear surface of the wafer 13 can be covered with a thermosetting adhesive to enhance adhesion between the wafer 13 and rear panel 5.

Although convenient, it is not necessary that the wafer 13 be affixed to the rear panel 5. By placing rear panel 5 in a horizontal position during assembly of sampler 1, wafer 13 can be temporarily held to surface 11 of rear panel 5 by gravity. Once the front and rear panels 3 and 5 are sealing together, wafer 13 is encapsulated in chamber 19 and sandwiched between rear panel 5 and window film 17.

Foam wafer 13 may be infused with fragrance oil before or after assembly of the sampler 1. Before assembly, wafer 13 can be injected with a dose of fragrance liquid which is absorbed into the foam. Thereafter, the front panel 3 and rear panel 5 can be mated together, enclosing wafer 13 within chamber 19 behind window opening 15.

Alternatively, the aperture 21 in the film may be made before assembly of the front and rear panels 3 and 5. Wafer 13 may be injected with the fragrance liquid through aperture 21 when aperture 21 is in registration with wafer 13. Aperture 21 can also be cut into film 17, in registration with the wafer 13, after mating of the front and rear panels 3 and 5 about wafer 13. Aperture 21 can be made while wafer 13 is infused with fragrance liquid. That is, the tool used to inject the fragrance liquid can also serve to cut aperture 21 into film 17.

Upon assembly of the sampler 1 by mating the inner surfaces of panels, heat is applied to the assembly whereby the panels, are bonded together where their thermosetting adhesive 7 coated surfaces are in mutual engagement.

With panels 3 and 5 fastened together, a peripheral margin 23 of the sheet of film 17 is entrapped between panels 3 and 5 adjacent the perimeter of window 15 thereby forming a boundary of the chamber 19 between film sheet 17 and the inner surface 11 of rear panel 5. The chamber 19, in which the wafer 13 is housed, is bounded by film sheet 17, inner film coated surface 11 of rear panel 5, and a seam 24 between film sheet 17 and inner film coated surface 11 of rear panel 5 circumscribing chamber 19 along the circumference of film sheet 17.

Since the aperture 21 is in the sheet of film 17 and, hence, at a boundary of the chamber 19, a mist of fragrance liquid can be sprayed directly from wafer 13, through aperture 21, to the ambient environment outside chamber 19. As the tiny droplets of fragrance liquid in the mist are dispersed into the air outside of chamber 19 they evaporate forming a vapor which can be sniffed for sampling the scent of the fragrance liquid.

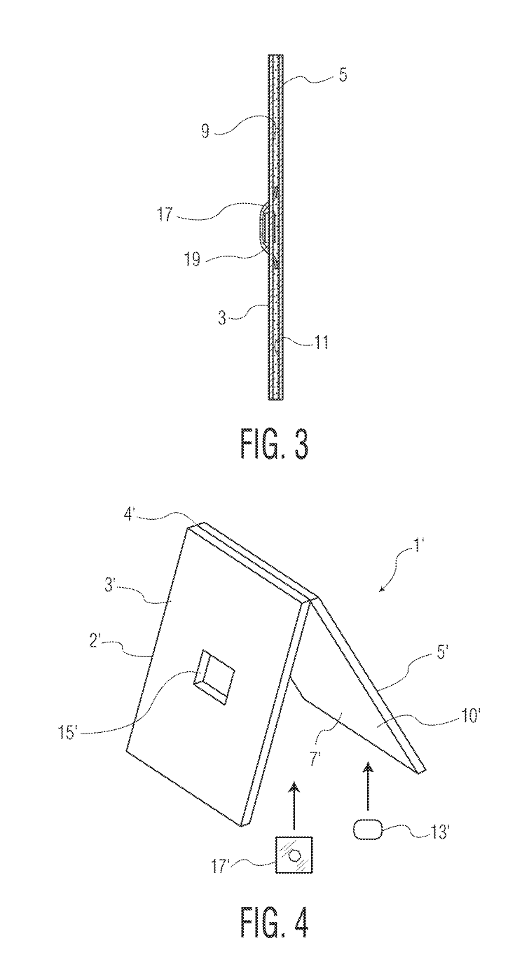

Referring now to FIG. 4 of the drawings, there is shown a sampler 1′ made from a rectangular card 2′ that has been scored along a line 4′ centered on the card 2′ so that panels 3′ and 5′ of card 2′ can readily be folded together. Sampler 1′ is identical to sampler 1 in all respects except as described below.

One surface 10′ of the card 2′ is laminated with a film having on its exposed surface a dry thermosetting adhesive 7′ as in the embodiment of FIGS. 1-3 described above. The panels 3′ and 5′ of the card 2′ are folded with their film laminated surfaces being inner surfaces which can be mated and then heat sealed together to form the sampler 1′ which, other than the connection between panels 3′ and 5′ along score line 4′ is similar to the sampler 1 shown in FIGS. 1-3.

Cut into front panel 3′ of card 2′ is a window 15′ which is shown to be square but which can be of virtually any shape. Before sealing panels 3′ and 5′ together, a sheet 17′ of a flexible non-resilient film, which may optionally be transparent, and which is large enough to completely cover the window opening 15′, is placed over window 15′. The wafer 13′ identical to the wafer 13 described with respect to FIGS. 1-3 is sandwiched between panels 3′ and 5′ in a chamber bounded by film sheet 17′ and rear panel 5′.

As will be seen below, the aperture from which the mist of fragrance liquid absorbed into wafer exits the sampler need not be in the film sheet which covers the window. The aperture can be virtually anywhere in the sampler.

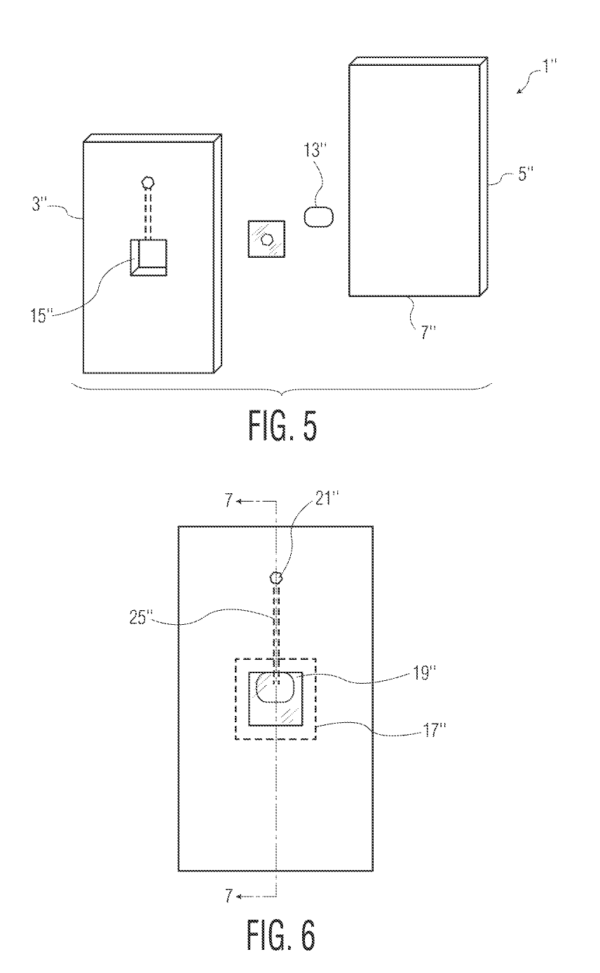

Referring now to FIGS. 5-7 of the drawings, there is shown an exploded perspective view of a sampler 1″ of yet another embodiment of the invention ready for assembly. Sampler 1″ is identical to sampler 1 in all respects except as described below.

As in the embodiment of FIGS. 1-3, the body of the sampler 1″ is formed by joining a front panel 3″ to a rear panel 5″ both of which have been cut from similar printable stock, e.g., card board or plastic having a surface to which a transparent film with an exposed surface coated with a dry thermosetting adhesive 7″ has been laminated. Again, the rear surface 9″ of the front panel 3″ and the front surface 11″ of the rear panel 5″ can be sealed together by application of heat.

The front panel 3″ has window opening 15″ therethrough which is covered by placing on the inside surface of the front panel 3″ a thin sheet of thin, flexible, nonresilient film 17″ slightly larger in profile than the window opening 15″.

Unlike film sheet 17 of the first embodiment of the invention, the sheet of film 17″ is not apertured. Instead, a channel 25″ leading from a chamber 19″ housing a foam spongelike wafer 13″ between film sheet 17″ and rear panel 5″ is provided between panels 3″ and 5″ by leaving an area of at least one of the rear face of the front panel 3″ and the front face of rear panel 5″ uncoated with the thermosetting adhesive 7″ that covers the remainder of the facing surfaces of panels 3″ and 5″.

When panels 3″ and 5″ are bonded together by heating the thermosetting adhesive 7″, the areas of the surfaces of the panels which have not been covered with adhesive 7″ remain detached and form inner walls of the channel 25″ through which a mist of the fragrance liquid in the wafer 13″ may be pumped when the wafer 13″ is compressed. Alternatively, the channel 25″ may be formed by not heating the surfaces of the panels which are to form the walls of the channel, e.g., by applying heat to the panels with a heating die that does not engage the areas of the surfaces of the panels 3″ and 5″ which are to form the walls of the channel 25″. As can be seen in FIG. 6, the channel 25″ runs from where the wafer 13″ is situated at a boundary of the chamber 19″ to an exit opening 21″ in one of the panel walls. Once the mist of fragrance liquid exits the chamber 19″ and enters the channel 25″ it begins to vaporize and mix with the air whereby the scent may be sampled by sniffing outside the exit opening.

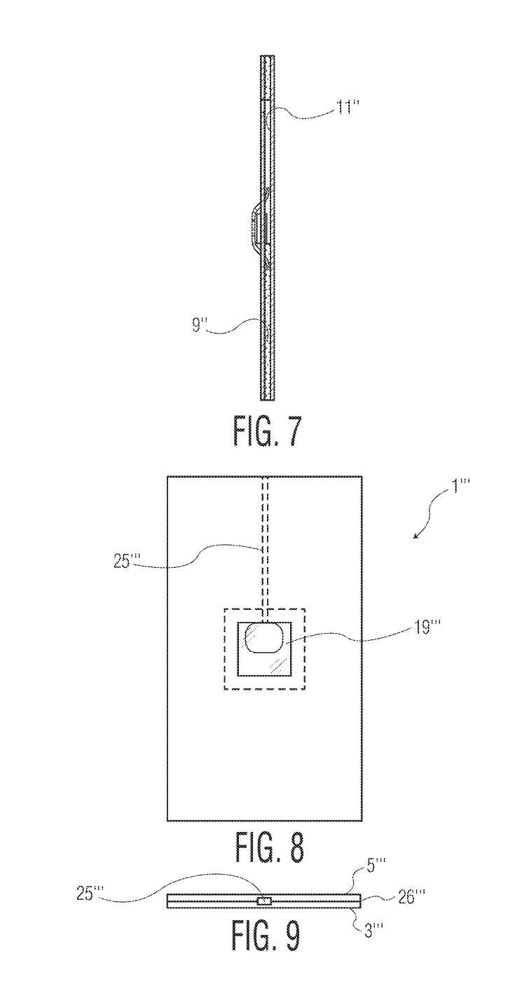

As can be seen in FIGS. 8 and 9, the aperture need not be through the face of one of the panels and but may, instead be at an edge of the sampler 1′″. Sampler 1′″ is identical to sampler 1″ in all respects except as described below.

In the latter case, the channel 25′″ extends from a boundary of chamber 19′″ to an outer seam 26′″ between panels 3′″ and 5′″. The volume of the channel 25′″ may be increased by scoring the panels before bonding them together, or even adding a tube or similar support having substantially rigid walls for keeping the channel 25′″ open and the surfaces of the panels 3′″ and 5′″ within the channel 25′″ from collapsing.

In use of any of the embodiments described above, a consumer can squeeze the foam wafer which contains the fragrance liquid by pressing the film covering the window to the chamber in which the wafer is housed against the panel behind the wafer. The pressure on the foam wafer inside the chamber causes a mist of the fragrance liquid stored in the foam wafer to escape from the chamber whereby it can be sniffed by the consumer.

Infusion of the fragrance liquid into the foam wafer can be accomplished by injecting the fragrance liquid into the foam wafer, or spraying or squirting the fragrance liquid onto the foam wafer, or soaking the foam wafer in the fragrance liquid.

The outer faces of the panels of the sampler can be printed with a graphic image or other advertising copy to identify and promote the scent product which is carried by the fragrance liquid contained in the foam material, to convey any message, or to merely give the sampler an aesthetically pleasing appearance. Where the film sheet is transparent, the area of the inner surface of the panel viewable through window may also be printed with a design and/or message.

It is to be appreciated that the foregoing specification describes four embodiments of a scent sampler and method for its manufacture to which variations and modifications may be made without departing from the spirit and scope of the invention.

What is claimed is:

1. A scent sampler comprising
a front panel having a liquid-impervious rear surface and a window opening,
a rear panel having a liquid-impervious front surface;
a layer of thermoplastic adhesive forming a liquid tight seal between said rear surface of said front panel and said front surface of said rear panel;
a sheet of a flexible nonresilient film disposed between said front panel and said rear panel and covering said window opening, said sheet of flexible nonresilient film and an area of said rear panel behind said window enclosing a liquid tight chamber, said chamber having an aperture at a boundary thereof, and
a wafer of a resilient, compressible, liquid-absorbent material, infusible with a fragrance liquid, disposed within said chamber proximate said aperture,
whereby pressure can be applied to said wafer through said flexible nonresilient film to spray a mist of said fragrance liquid through said aperture for sampling a scent emitted by said fragrance liquid.

2. A scent sampler in accordance with claim 1 wherein said first panel and said second panels are two adjacent panels of a single piece of sheet material, and said first panel is folded onto said second panel.

3. A scent sampler in accordance with claim 1 wherein said aperture is in said flexible nonresilient film.

4. A scent sampler in accordance with claim 1 wherein a channel between said front panel and said rear panel runs from said chamber to an exit opening spaced from said chamber for enabling said mist to be expelled from said sampler through said exit opening.

5. A scent sampler in accordance with claim 4 wherein said exit opening is in one of said front panel and said rear panel.

6. A scent sampler in accordance with claim 4 wherein said exit opening is between said front panel and said rear panel.

7. A scent sampler in accordance with claim 1 wherein said wafer comprises a foam material.

8. A scent sampler in accordance with claim 7 wherein said foam material comprises an open cell hydrophilic foam.

9. A scent sampler in accordance with claim 8 wherein said open cell hydrophilic foam comprises polyester.

10. A scent sampler in accordance with claim 1 wherein at least one of said front panel rear surface and said rear panel front surface comprises a liquid impervious barrier film laminated onto a printable substrate.

11. A scent sampler and air freshener in accordance with claim 10 wherein said printable substrate has a printable surface over which said barrier film is laminated.

12. A scent sampler in accordance with claim 11 wherein said printable surface has at least one of text and graphics printed thereon.

13. A scent sampler in accordance with claim 12 wherein said sheet of a flexible nonresilient film is transparent for viewing of printing on said rear panel through said window.

14. A scent sampler in accordance with claim 1 wherein said wafer is affixed to said front surface of said rear panel.

15. A method of making a scent sampler comprising,
covering at least one of a rear surface of a front panel and a front surface of a rear panel with a thermosetting adhesive,
making a window opening in said front panel,
mounting a sheet of a flexible nonresilient film over said window opening between said front panel window opening and said rear panel;
placing between said flexible nonresilient film and said rear panel a wafer of a resilient, compressible, liquid-absorbent material,
mating said rear surface of said front panel and said front surface of said rear front panel thereby forming a chamber between said flexible nonresilient film and said rear panel housing said wafer,
forming an aperture in a boundary of said sampler, and
bonding said front panel and said rear panel together by heating said thermosetting adhesive and then allowing said thermosetting adhesive to cool.

16. A method of making a scent sampler according to claim 15 further comprising forming an opening leading from said chamber to the air outside said sampler.

17. A method of making a scent sampler according to claim 16 further comprising forming said opening in said flexible nonresilient film 17.

18. A method of making a scent sampler according to claim 16 further comprising forming said opening by creating a channel between said front panel and said rear panel.

19. A method of making a scent sampler according to claim 18 further comprising leaving an area of at least one of said rear surface of said front panel and said front surface of said rear panel within said channel free of said thermosetting adhesive.

20. A method of making a scent sampler according to claim 18 further comprising withholding heat from an area of at least one of said rear surface of said front panel and said front surface of said rear panel within said channel when bonding said front panel and said rear panel together by heating said thermosetting adhesive.
